(19) United States
(12) Patent Application Publication
(10) Pub. No.: US 2007/0132562 A1
(43) Pub. Date: Jun. 14, 2007

(54) Facilitated safe car steering device

(76) Inventors: Toshihiro Fukumoto, Tokyo (JP); Keiko Ebato, Tokyo (JP)

Correspondence Address: BROWDY AND NEIMARK, P.L.L.C.;624 NINTH STREET, NW, SUITE 300, WASHINGTON, DC, 20001-5303, US

(21) Appl. No.: 10/584,238

(22) PCT Filed: Dec. 25, 2003
(86) PCT No.: PCT/JP03/16738

§ 371 Date: Jan. 17, 2007

(51) Int. Cl. B60Q 1/00; G06F 7/00; G01C 21/00

(52) U.S. Cl. 340/435; 701/36; 701/207

(57) ABSTRACT

A facilitated safe care steering device capable of preventing such problems with present transportation vehicles and working vehicles that, since these vehicles are formed to be excessively dependent upon the viewing, sensing, and judgement of drivers, these vehicles cannot be said to be able to cope with the physical decline of the drivers due to secular change, and a large number of serious accidents occur due to the physical decline, wherein the physical decline is mechanically and optically supported by recognizing the state of roads, traffic controls, and dangerous objects to the vehicles with a systematic recognizing method, and the vehicles carry a system for physically avoiding the accident when they actually encounter the accident to assure the safe traveling of the vehicles on the roads. There is no technology other than this technology in which social-friendly road traffic vehicles are manufactured in optimum safe and economical conditions to meet the requirements of road and traffic regulations and rules which become complicated more and more.

### TECHNICAL FIELD

The present invention relates to a system or machinery minimizing a human error in driving by reducing a circumference watch burden of a car for safe driving of a driver, automating a run of a car and putting a car in a garage, with which the most of beginners have difficulty.

And, this invention is a system or machinery letting reduce the possibility that a serious traffic accident occurs to the maximum when a car caused malfunction by misunderstanding of a driver.

Furthermore, this invention is a system which prevents an abnormality run by analyzing automatically whether operation intention of a driver and the situation of a current road are agreed.

Moreover, this invention is a system which driving of a car enables with a senior citizen in coming aging society by advancing current car navigation system which utilize traffic information and a road map using GPS, reducing fatigue of a driver, and enabling safe driving.

In addition, this invention is a system which reducing of a fuel efficiency and a amount of discharge of a pollution substance by digitizing operation of a car and electronically controlling.

Safety in driving of a car depends on circumference watch by human eyes for most. Therefore, if a state of eyes and a state of ability for judgment and a state of health of a driver is bad, a serious traffic accident can occur.

It is possible to drive a car depending on a traffic condition by always operating a steering wheel, an accelerator, brakes, pedals such as clutches, and the lever which operates a gearbox with both hands both legs.

However, there are many cases that a function of a car which a designer aimed at is not used enough so that there is an ability difference by an individual.

As a result of not using a function of a car which a designer aimed at enough, Load to environment increases because of increasing a amount of discharge of global warming gas by increasing a amount of discharge of a pollution material and fuel consumption.

Safety in driving of a car depends on ability of a driver now.

However, in statistics, human motor nerves and judgment as the whole declines with progress of aging society slowly because a ratio of a senior citizen is to increase with progress of aging society.

Therefore, necessity of a safety device automated automatically rises as means to raise safety of driving.

Therefore, this invention offers a device which raises safety and reduces human fatigue, and evades an accident automatically.

This invention offers a device which let ability for management of a driver increase and contributes to prevention of fatigue at the time of driving.

### DISCLOSURE OF INVENTION

The present invention relates to a system comprising; changing lens angles of elemental devices such as CCDV; focusing object images provided by devices; patterning images detected in shortest distance from 360 degree by measuring distance from objects; and collating patterned data for determination of risks.

The patterning comprises; dividing patterns roughly to children, ages, cars, and animals; analyzing normal behavioral patterns for each of them; recording; and predicting actions of objects over the next 0.1-5 seconds to avoid risks certainly.

Vertical information of a spot is used added to graphic information provided by car navigation system using GPS in order to obtain automated driving of cars.

That is, three-dimensional road information is used consistently.

Additionally, the information such as meanings of road sign, guardrail, center line, no-passing zone, passing zone are used as well as the information of the driving operation.

The information is patterned and compared with information detected by own car to convey it to the control devices in a car.

Wide angle lenses are used for the elemental devices to provide images. Changing of the lens angles causes focusing images provided by plural lenses. Distances from the object are measured by changing of the lens angles or changing of the photographic devices.

The elemental devices detect objects. Patterned objects are compared with patterns stored in a memory device to predict moving states of the objects from those patterns. Therefore, position of the objects over a next few seconds are predicted, and the risks of cars are calculated to avoid them.

Plural operational sticks are used to control the driving. Those operational sticks are fly-wire type. All of information of sticks is replaced to electrical signals to transmit various control devices through operation control device.

One control stick for controlling speed, driving direction, and acceleration comprises an actuation button as a safety device to operate.

Another control stick is used to transmit the driving mode to a drive control panel. It is used to set driving modes such as automated driving mode, manual driving mode, overtaking mode, parking mode. It comprises an actuation button as a safety device to operate.

In addition, it is possible to combine these plural sticks into one stick.

In preparation for the night time, supplemental lightning such as an infrared light may be placed to recognize object, otherwise elemental devises such as CCD could not work enough to recognize objects around them.

Two or more elemental devices are placed in either side of backward to confirm around 360 degree consistently.

Four or more photographic devices and a photographic control device for dividing graphical contents are placed to recognize patterns in 360 degree consistently.

Protective coverings are placed in front of lenses and fill lights which are placed in front of elemental devices. In addition, cleaning equipments or other equipments for removing sludge or dust are placed not to cut off the view.

The present invention provides a transit vehicle for ages or physically-handicapped person to use easily by omitting steering operations and pedals such as a clutch, a brake and an accelerator. In addition, the present invention contributes to the prevention for the serious accidents caused by illusion or the error by oversight of the traffic signals.

Highly directional antennas are placed on front and backside to catch a high-frequency radio wave of the noise radiated from carbon brush which is placed at a rotor of the electrical motor in order to determine the distance between two cars.

It makes easy to find out the near collision.

### BRIEF DESCRIPTION OF THE DRAWINGS

FIG. 1 is a schematic diagram showing a mounting location for sensors, fill lights, and operational sticks of a car.

FIG. 2 is a schematic diagram showing sensors and lenses.

FIG. 3 is a schematic diagram showing a operation stick 1.

FIG. 4 is a schematic diagram showing a operation stick 2.

FIG. 5 is a schematic diagram showing a driving control panel.

FIG. 6 is a schematic diagram showing a driving sign-board.

FIG. 7 is a schematic diagram showing focusing the images provided by two elemental devices and recognizing distances and patterns for assessing in a centralized computer.

### BEST MODE FOR CARRYING OUT THE INVENTION

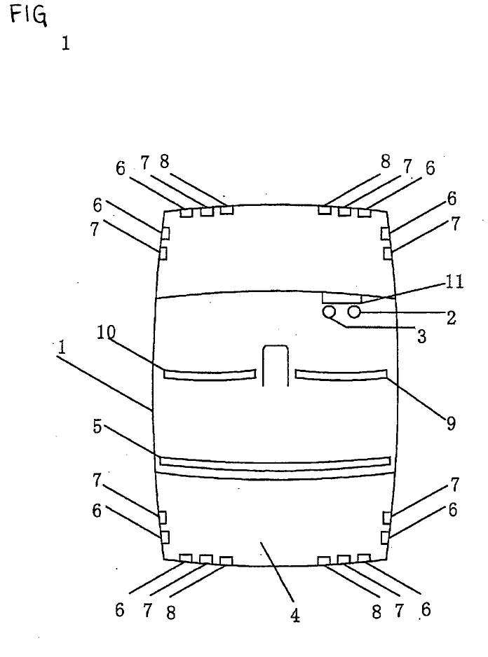

FIG. 1 is a schematic diagram showing a mounting location for sensors, fill lights, and operational sticks of a car.

Sensors might be mounted with enough spacing in order to measure distances between two objects correctly.

Operational sticks might be placed in a location and angles with height control to enable a driver to operate them easily.

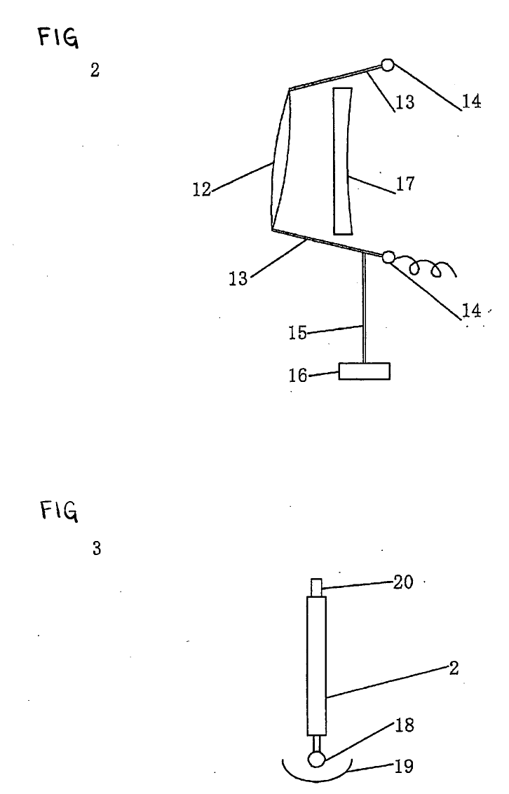

FIG. 2 shows the relationship between sensors and lenses.

Lenses are driven by electricity, oil pressure, or air pressure etc., and connected with equipments which detect the angles of the focusing provided by the sensors to measure distance to objects.

FIG. 3 is a schematic diagram showing a operation stick 1.

Leaning angle of the magnetism or the optical device mounted on a top of the operational sticks is detected by a light-receiving panel. It is transmitted to the driving control panel by electrical signal, and then, transmitted to the driving control panel such as engine, steering, brake, and mission by electrical signal to be reflected by driver's intent.

In addition, an acknowledge button is placed on the end of the operational stick as a safety apparatus for not working in unintended operation.

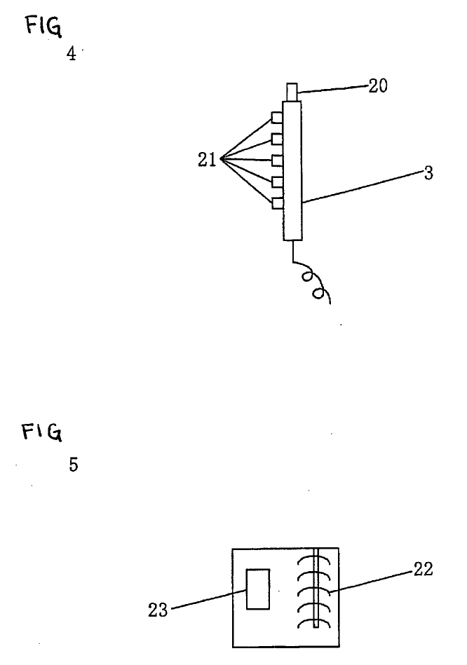

FIG. 4 is a schematic diagram showing a operation stick 2.

Buttons for various driving mode are placed on the operational sticks.

For example, automated driving, manual driving, right turn, left turn, and parking mode or the others that driver's favorite can be arranged. These modes are transmitted to the driving control panel by the electronic signals.

FIG. 5 is a schematic diagram showing a driving control panel.

The driving control panel comprises memory units such as disks, RAM, flash memory, DVD or the other units created hereafter and instruction execution units. It recognizes patterns of the objects, and distance detected by the operational sticks 1, operational sticks 2 or the sensors. It assures the risks, and shows operations for avoiding them. It reflects driver's intention and assesses the risks for them. If it is driven using automated diving mode, the guardrail and or the center lines are recognized for the securities of the forward and backward.

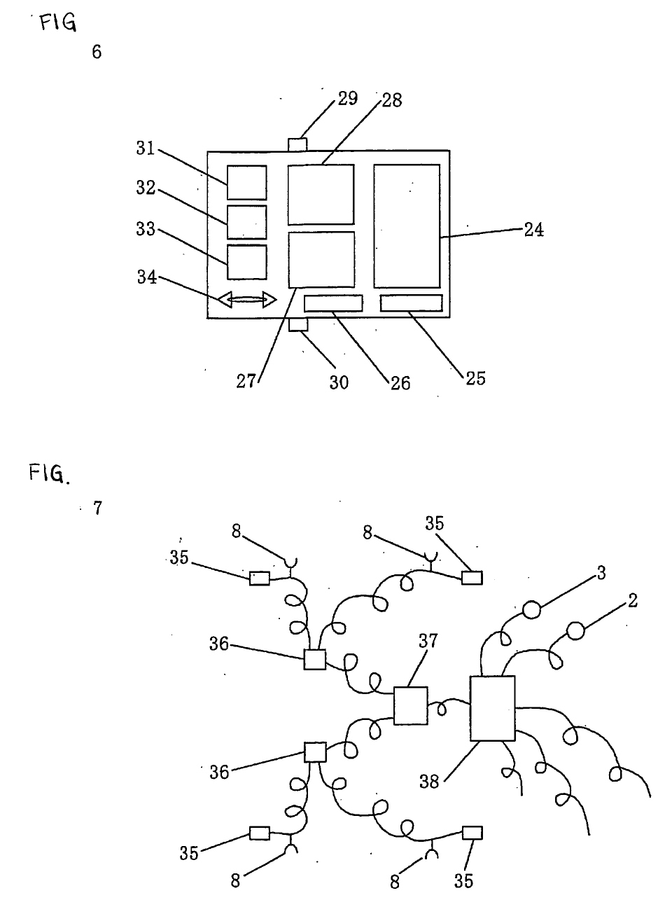

FIG. 6 is a schematic diagram showing a driving sign-board.

The driving sign-board mainly comprises a map showing a location of the car. It also shows notices or regulations based on the traffic signs.

It shows scheduled driving route, if destination, access point and starting point is provided.

The driving alarm device is a display showing the occasion required avoiding, the current driving mode, the notice etc. in order to drive safely.

FIG. 7 is a schematic diagram showing patterning for images provided by photographic device and the high-frequency radio wave provided by antenna as well as distances.

The information is sent to control equipment by way of memory units. Pattering is assessed for safety driving to control driving.

And then, it is sent to driving control device (38) which assesses information provided by driving operational sticks in order to control comprehensively.

### EXPRESSIONS OF REFERENCE LETTERS

1 Main body of car
2 Operation stick 1
3 Operation stick 2
4 Trunk room
5 Rearseat
6 Exposure element
7 Infrared auxiliary lighting equipment
8 Super-directional antenna for electromagnetic waves
9 Driver's seat
10 Seat next to the driver
11 Driving indication board
12 Lens
13 Driving means
14 Lens drive motor
15 Lens angle detection stick
16 Object estrangement distance sensing device
17 Exposure element
18 Magnetic or optics device
19 Operation stick angle detection board
20 Safe button
21 Various driving mode setting button
22 DISK storage device
23 Pattern recognition and a driving control calculation device
24 The present operation position map display of 3-dimension
25 The present speed visual display unit
26 Number of the engine turns visual display unit
27 Planned run site figure display unit
28 Operation alarm equipment
29 Front near miss alarm lamp
30 Back near miss alarm lamp
31 Front traffic restriction display
32 Attention object visual display unit in driving
33 Displays, such as a run destination, a course ground, and the remaining time required
34 Direction instructions, light-related visual display unit
35 Photography equipment
36 Image composition and range-finding and a patterning microcomputer
37 A microcomputer for instructions such as dangerous judgment and evasion of a patternized picture
38 General driving control units

### INDUSTRIAL APPLICABILITY

The present invention relates to a car to be omitted a steering wheel, a brake pedal, an accelerator pedal and a clutch and driven safely with one or more operational sticks as a transit vehicle or a service vehicle.

The driving sign-board showing the road condition, route to the destination, current speed, and condition of acceleration and decelerating, information of the dangerous material and remaining fuel is used in place of display mainly containing speedometer which is disposed in transit vehicles before.

In the present invention, automated driving or manual driving is selected depending on driver's skills. The present invention provides a safe transit vehicle or a service vehicle with decreased possibility of an accident.

1. System for vehicles to specify the running location on the road comprising:
recording lateral information on the road provided by GPS or a car navigation system as well as information of buildings on the road, longitudinal level of the ground, and existence of the guardrail;
constructing a confirmation system of the car location combining a large-volume date recording system such as CD, DVD, or the other devices developed from now to obtain vertical images of a car location and a vertical information as well as a road information currently available to improve a dimensional location confirmation system; and
calculating an actual location such as a distance from the end of the road or the center line by using the confirmation system and analyzing images provided by elemental devices placed in front and backward fixedly or turnably to specify the current location of the car.

2. System for optimizing and performing caution or driving to avoid an accident based on the risk in accordance with claim 1, comprising:
digitizing images by using CCD or CMOS elements for driving safety;
discriminating and managing the risks for a car by comparing images or object information which is information of object of cars, human waling, object approaching to the car, guardrail, center line, and traffic sign recorded in ROM or DISK etc. and patternized after calculating distances and shapes;
measuring distances from between the object and a car continuously;
calculating moving states of the object and distances from a car near-future to control as information of the risks; and
analyzing these information and the risks based on speed, direction, and weight of the car to calculate the location of the car after few minutes.

3. System for driving automatically to the destination arranged in accordance with claim 1, preliminarily comprising:
forecasting a location of the car by taking in the location of a car correctly; and
analyzing a distance and shifting of the object in a shortest distance using images provided by elemental devices.

4. System for controlling driving by using operational sticks in accordance with claim 3, comprising:
replacing steering gear to one or two operational sticks and omitting a steering wheel, brake, pedals of an accelerator and a clutch;
wherein the operational sticks are fly-wire type,
the first operational stick detects the driving directions or the shifting from the center line to analyze and replace to the electronic information and transmit them to the various control device such as engine control device, control device of tire direction, and gear control device, and
the second operational stick is used for setting driving mode, reporting driver's intention to the driving control device, and managing control device to avoid the mechanical error; and
setting driving mode such as automated driving, overtaking driving, back up, parking, following mode, on-the-street parking mode, or leading mode in order to transmit driving control device.

5. System for stopping a vehicle when the driving safety is not provided because general system and driving information for drivers using operational sticks is against the information provided by the system according to claim 3.

6. An assist device for measuring distances between a car and objects around the car placed in a directional light or a back light comprising light emitting system such as infrared light for detecting by elemental devices in the night time.

7. System for automated driving according to claim 1, comprising:
a program depends on feature of vehicle to build onto a driving modes;
images provided by elemental devices; and
controlling numerical information based on the images.

8. A device for keeping view comprising removal device for dust, mud and a drop of water using water, organic compound driven by electric, air or oil pressure placed in front of elemental devices, and
lenses for recognizing direction by exposing in wide angle.

9. A device according to claim 8 for shifting lenses and focusing images for objects to measure distances between the objects and a car using a figure of elemental devices and changing angles for lenses.

10. System according to claim 1 comprising the driving sign-board which shows the information for location of the buildings, traffic sign, road condition, current speed, condition of acceleration and decelerating, and condition for the change of the direction, in place of the display mainly containing speedometer which is used before.

11. System according to claim 1 for using the ratio wave provided by engine and measuring distances comprising:
rotating dynamos;
catching the electromagnetic waves by radiated from spark which is contacted with carbon brush, by two directional antenna placed on right side and left side;
amplifying;
measuring distance from sources of waves;
calculating by microcomputer the risks of the car in front and in backward based on a speed of each cars; and
lightning the alarm lump or driving to avoid the risks automatically depending on the result.
